(19) United States
(12) Patent Application Publication
(10) Pub. No.: US 2025/0356568 A1
(43) Pub. Date: Nov. 20, 2025

(54) CAMERA FOOTAGE MANAGEMENT SYSTEM

(71) Applicant: TOYOTA JIDOSHA KABUSHIKI KAISHA, Aichi-ken (JP)

(72) Inventors: Norimasa KOBORI, Tokyo-to (JP); Quan KONG, Tokyo-to (JP); Hitoshi KAMADA, Tokyo-to (JP); Betty Magali Claire LE DEM, Tokyo-to (JP); Hsuan-Kung YANG, Tokyo-to (JP); Tsu-Ching HSIAO, Tokyo-to (JP); Yohei OZAO, Tokyo-to (JP)

(21) Appl. No.: 19/207,363

(22) Filed: May 14, 2025

(30) Foreign Application Priority Data
May 17, 2024 (JP) 2024-081072

(51) Int. Cl. G06T 13/40; G06V 20/40; G06V 20/52; G06V 40/10

(52) U.S. Cl. CPC G06T 13/40; G06V 20/41; G06V 20/52; G06V 40/10

(57) ABSTRACT

A processing circuitry generates recognition information on an object shown in camera footage by object recognition processing on the camera footage. The processing circuitry also generates linguistic information on a scene shown in the camera footage by linguistic processing on the camera footage and generates scene information in which the recognition information on a human and the linguistic information on the scene are associated with each other and stores the scene information in the memory device. The processing circuitry further performs reproduction processing of the scene shown in the camera footage based on the scene information. In the reproduction processing, an abstracted image of a space shown in the camera footage is rendered and an abstracted image of the human is rendered thereon. In the reproduction processing, caption information generated from the linguistic information is added to the abstracted image of the space to generate a reproduced image.

The present application claims priority under 35 U.S.C. § 119 to Japanese Patent Application No. 2024-081072, filed on May 17, 2024, the contents of which application are incorporated herein by reference in their entirety.

### TECHNICAL FIELD

The present disclosure relates to a system for managing camera footage.

### BACKGROUND

JP2006295251A discloses a system for image processing surveillance camera footage and outputting the processed footage from an external monitor. The system of the related art extracts a human from surveillance camera footage, detects gesture and action of the extracted human, and calculates importance of the detected gesture and action. The system of the related art also determines a range of the surveillance camera footage to be subjected to the image processing based on the calculated importance. In the image processing, privacy protection processing such as mosaic processing and smoothing treatment is performed on the range of the surveillance camera footage to be subjected to the image processing. That is, in the system of the related art, video subjected to the image processing corresponding to the importance of the detected gesture and action of the human is output from the external monitor.

The system of the related art also performs scene analysis of the surveillance camera footage. When the video scene is determined to be abnormal in the analysis, text information indicating that the scene is an abnormal scene is added to the video subjected to the image processing.

Examples of the documents showing the technical level in the technical field related to the present disclosure include JP2022056533A, JP2019144830A and JP2002024963A, in addition to JP2006295251A.

In the system of the related art, the importance of the human gesture and action is calculated by referring to a score table created in advance. However, depending on granularity of information in the score table, the range to be subjected to the image processing may not be determined correctly, and privacy of humans shown in the surveillance camera footage may not be sufficiently protected.

According to the system of the related art, it is expected that the text information indicating the abnormal scene is added to the output video from the external monitor, and thus it is easy to notify a viewer of the external monitor that the video scene is abnormal. However, in order to reproduce the output video to which such text information is added, it is necessary to store the video subjected to the image processing in combination with the text information, and there is a problem that the data size of the video increases.

An object of the present disclosure is to provide a technique capable of reducing data size required for reproducing a scene shown in camera footage while protecting the privacy of humans shown in the camera footage.

### SUMMARY

The present disclosure is a management system for camera footage and has the following features.

The system includes a memory device, processing circuitry, and a display device. The camera footage is stored in the memory device. The processing circuitry is configured to perform various processing. The display device is configured to output an image.

The processing circuitry is configured to: generate recognition information on an object shown in the camera footage by object recognition processing on the camera footage stored in the memory device; generate linguistic information on a scene shown in the camera footage by linguistic processing on the camera footage stored in the memory device; when the recognition information on the object include recognition information on a human, generate scene information in which the recognition information on the human is associated with the linguistic information on the scene generated by the linguistic processing on the camera footage in which the human is recognized and store the scene information in the memory device; and perform reproduction processing on a scene shown in the camera footage based on the scene information stored in the memory device.

The reproduction processing comprises: rendering an abstracted image of a space included in the camera footage based on the recognition information on a static object included in the scene information; rendering an abstracted image of the human included in the camera footage on the abstracted image of the space based on the recognition information on the human included in the scene information; generating caption information on the scene based on the linguistic information on the scene included in the scene information; and generating a reproduced image to be output from the display device by adding the caption information to the abstracted image of the space in which the abstracted image of the human is rendered.

According to the present disclosure, the reproduction processing of the scene shown in the camera footage is performed using an image obtained by rendering the abstracted image of the human shown in the camera footage on the abstracted image of the space shown in the camera footage, to which the linguistic information on the scene shown in the camera footage is added as a caption. Here, the abstracted images of the space and the human are rendered based on the recognition information on the object generated by the object recognition processing on the camera footage. Therefore, data size required for reproducing the video scene can be reduced as compared with a case where live video data is used or a case where image data subjected to privacy protection processing of the related art is used. In addition, since the abstracted image of the human is used, it is possible to protect the privacy of the human.

### BRIEF DESCRIPTION OF THE DRAWINGS

FIG. 1 is a block diagram illustrating an example of an overall configuration of a management system of a camera footage according to an embodiment of the present disclosure;

FIG. 2 is a block diagram illustrating an example of a functional configuration of a data processing device illustrated in FIG. 1;

FIG. 3 is a conceptual diagram for explaining an example of reproduction processing by a reproduction unit shown in FIG. 2;

FIG. 4 is a conceptual diagram for explaining another example of the reproduction processing by the reproduction unit shown in FIG. 2; and

FIG. 5 is a block diagram illustrating another example of the functional configuration of the data processing device illustrated in FIG. 1.

### DESCRIPTION OF EMBODIMENT

Hereinafter, an embodiment of the present disclosure will be described with reference to the drawings. In the drawings, the same or corresponding parts are denoted by the same reference numerals, and the description thereof will be simplified or omitted.

### 1. OVERALL CONFIGURATION EXAMPLE

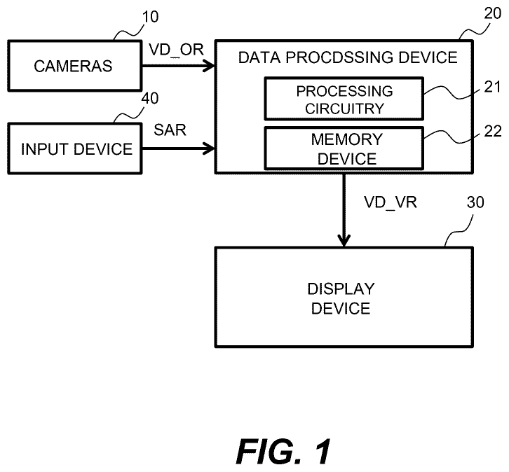

FIG. 1 is a block diagram illustrating an example of an overall configuration of a management system of a camera footage according to the embodiment of the present disclosure. In FIG. 1, cameras 10, a data processing device 20, a display device 30, and an input device 40 are illustrated as configurations of the management system according to the embodiment. The cameras 10, the display device 30, and the input device 40 communicate with the data processing device 20 via a communication network (not shown). The communication network is not particularly limited, and a wired or wireless network may be used.

The cameras 10 are installed in any space indoors and outdoors. The installation position and the imaging range of the cameras 10 are known. Each of the cameras 10 acquires video within an imaging range thereof. Each of the cameras 10 transmits the video (i.e., camera footage VD) acquired by the respective cameras 10 to the data processing device 20 together with its own identification information. The total number of the cameras 10 is at least one. A part or all of the imaging ranges of the two or more cameras may overlap.

The data processing device 20 includes at least one processing circuitry 21 and at least one memory device 22. Examples of the processing circuitry 21 include a general-purpose processor, a special-purpose processor, a central processing unit (CPU), a graphics processing unit (GPU), an application specific integrated circuit (ASIC), and a field-programmable gate array (FPGA). Examples of the memory device 22 include a hard disk drive (HDD), a solid state drive (SSD), a volatile memory, and a nonvolatile memory.

The processing circuitry 21 develops various programs stored in the memory device 22 and processes various data stored in the memory device 22. The data process by the processing circuitry 21 includes processing of the camera footage VD. In the data processing of the camera footage VD, a two-dimensional or three-dimensional virtual image is generated from the images constituting the camera footage VD, and is output to the display device 30. Hereinafter, for convenience of description, a video image formed of a virtual image is also referred to as a “video image VD_VR”. The camera footage VD from which the virtual image is generated is also referred to as “video VD_OR”. Details of an example of the data processing of the video VD_OR will be described later.

The display device 30 displays various data. The various data displayed on the display device 30 is provided to the user of the management system. The various data displayed on the display device 30 includes the video VD_VR. Examples of the display device 30 include a liquid crystal display, an organic EL display, and a head-up display.

The input device 40 is operated by a user of the management system. Examples of the input device 40 include a keyboard, a mouse, a touch panel, and a microphone. Input information particularly relevant to the embodiment includes search information SAR. The search information SAR is information for searching for a scene shown in the video VD_OR. The search information SAR includes character string information. When the input device 40 is a microphone, sound information input from the microphone is converted into character string information.

### 2. FUNCTION CONFIGURATION EXAMPLE

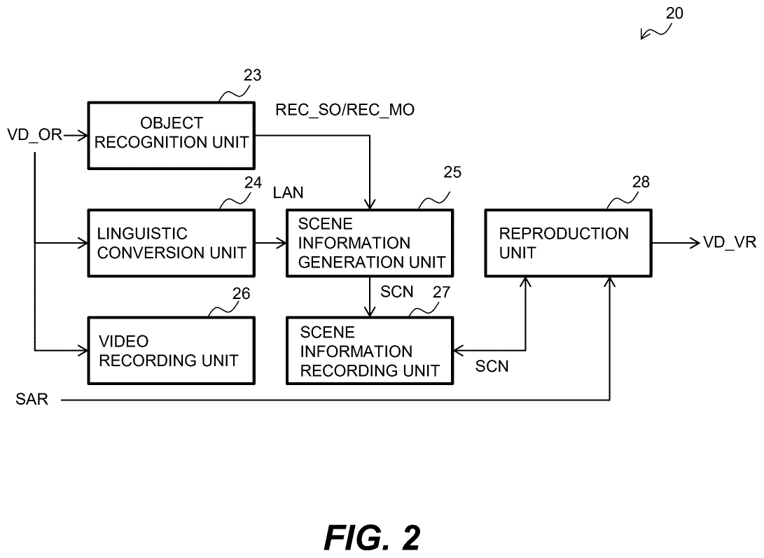

FIG. 2 is a block diagram showing an example of a functional configuration of the data processing device 20 shown in FIG. 1. In FIG. 2, an object recognition unit 23, a linguistic conversion unit 24, a scene information generation unit 25, a video recording unit 26, a scene information recording unit 27, and a reproduction unit 28 are depicted as function blocks of the data processing device 20. These function blocks are realized by cooperation of the processing circuitry 21 and the memory device 22 shown in FIG. 1, for example.

The object recognition unit 23 performs “object recognition processing” for recognizing an object included in an image (hereinafter, also referred to as an “image IMG_OR”) constituting the video VD_OR. In the object recognition processing, for example, an object is detected using a You Only Look Once (YOLO) network, a Single Shot multi-box Detector (SSD) network, or the like. The detection targets in the object recognition processing are a static object SO and a moving object MO. Examples of the static object SO include a building, a construction, and a natural object. Examples of the moving object MO include a human, a robot, a bicycle, and a vehicle.

In the object recognition processing, recognition information REC_SO of the static object SO and recognition information REC_MO of the moving object MO are generated. The recognition information REC_MO includes recognition information REC_HM of the human HM and recognition information REC_NHM of a moving object (e.g., a robot, a bicycle, a vehicle, etc.) NHM other than the human HM. The recognition information REC_SO and the recognition information REC_MO include information on type of the object and information on the detected time of the object. The recognition information REC_SO and the recognition information REC_MO are transmitted to the scene information generation unit 25.

In the object recognition processing, a two-dimensional pose (2D Pose) and a three-dimensional pose (3D Pose) of the human HM are further estimated. The two-dimensional pose and the three-dimensional pose are represented by parts such as joints, a head, hands, and feet and lines connecting the parts. The information on the two-dimensional pose and the three-dimensional pose is added to the recognition information REC_HM of the human HM. In the object recognition processing, tracking of the human HM may be performed. In the object recognition processing, processing for identifying the same person between two or more cameras 10 (human re-identification processing) may be performed. Tracking information and re-identification information are also added to the recognition information REC_HM of the human HM. Note that the pose estimation, tracking, and re-identification are well-known techniques, and the techniques applicable to the present disclosure are not particularly limited.

The linguistic conversion unit 24 performs “linguistic processing” for providing linguistic information LAN to a scene shown in video VD_OR. In the linguistic processing, for example, a text describing a scene shown in the video VD_OR is generated using a framework based on large language models (LLM models). The text describing the scene includes, for example, a description of the environment shown in the video VD_OR, a description of the human and the surrounding object shown in the video VD_OR, a description of the interaction between the human and the surrounding object, and the like. In another example, Vision Language Models (VLM models) are used to generate text describing the scene shown in the video VD_OR.

The text output from such a learning model is an example of the linguistic information LAN. The linguistic information LAN includes information on a start time and an end time of the scene described by text. The linguistic information LAN is transmitted to the scene information generation unit 25.

The scene information generation unit 25 generates scene information SCN by associating the information (recognition information REC_SO and recognition information REC_MO) received from the object recognition unit 23 with the information (e.g., the linguistic information LAN) received from the linguistic conversion unit 24. The scene information SCN is generated by associating the scene time information included in the linguistic information LAN with the object detected time information included in the recognition information REC_SO or the recognition information REC_MO. The scene information SCN is transmitted to the scene information recording unit 27.

The video recording unit 26 stores the video VD_OR received from the cameras 10 in the memory device 22 shown in FIG. 1. Since the data size of the video VD_OR stored in the memory device 22 is large, the video VD_OR stored in the memory device 22 is compressed or deleted after a certain period of time has elapsed. The video VD_OR stored in the memory device 22 can be referred to in a scene search described below or in updating scene information described below.

The scene information recording unit 27 stores the scene information SCN in the memory device 22 shown in FIG. 1. It is desirable that the memory device 22 in which the scene information SCN is stored and the memory device 22 in which the video VD_OR is stored are different equipment. The video scene information SCN stored in the memory device 22 is compressed or deleted after a predetermined period of time has elapsed, as in the case of the video VD_OR. However, since the video VD_OR and the scene information SCN are stored in the different memory devices 22, even if the scene information SCN is deleted from the memory device 22 by mistake, the scene information SCN can be generated again from the video VD_OR stored in the different memory device 22.

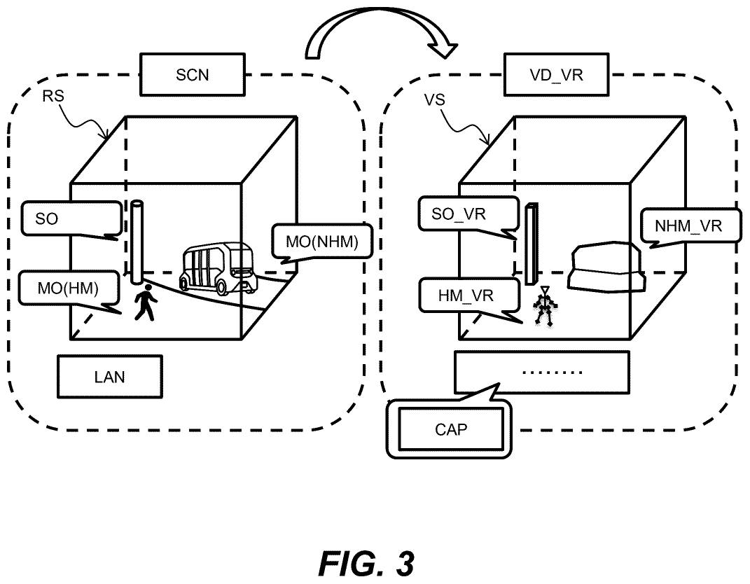

The reproduction unit 28 performs “reproduction processing” for reproducing a scene shown in the video VD_OR based on the scene information SCN stored in the scene information recording unit 27. FIG. 3 is a conceptual diagram for explaining an example of reproduction processing by the reproduction unit 28 shown in FIG. 2. In the left side of FIG. 3, a real space RS reflected in the video VD_OR included in the scene information SCN is drawn. In the real space RS, a static object SO and a moving object MO (a human HM and a moving object NHM other than the human HM) exist, and these objects are detected by object recognition processing.

In the reproduction processing, a virtual space VS abstractly representing the real space RS shown in the video VD_OR is rendered. The virtual space VS is represented by the same world coordinate system (X, Y, Z) as the real space RS. In the virtual space VS, a static object (virtual static object) SO_VR is defined which corresponds to the static object SO existing in the real space RS and which is obtained by abstracting the static object SO. The configuration (e.g., a position, an orientation, a shape, a size, etc.) of the virtual static object SO_VR is defined by the recognition information REC_SO of the static object SO. Therefore, the configuration of the virtual static object SO_VR substantially matches that of the static object SO.

In the reproduction processing, the human HM included in the video VD_OR is rendered in the virtual space VS. When rendering the human HM, the configuration (e.g., the position, the posture, the size, and the like) of the human (virtual human) HM_VR obtained by abstracting the human HM is defined based on the recognition information REC_HM of the human HM. The pose of the virtual human HM_VR is defined based on the two-dimensional pose or the three-dimensional pose included in the recognition information REC_HM. Therefore, in the example shown in FIG. 3, the virtual human HM_VR is represented in a skeleton shape.

When the moving object NHM other than the human HM is shown in the video VD_OR, the moving object NHM is rendered in the virtual space VS simultaneously with the human HM in the reproduction processing. When rendering the moving object NHM, the configuration (e.g., the position, the orientation, the shape, the size, etc.) of the moving object (virtual moving object) NHM_VR obtained by abstracting the moving object NHM is defined based on the recognition information REC_NHM of the moving object NHM.

In addition to the rendering of the virtual space VS, in the reproduction processing, caption information CAP of a scene shown in the video VD_OR is generated based on the linguistic information LAN. The caption information CAP is, for example, a description of the human HM included in the video VD_OR in the linguistic information LAN or a summary of the description. When the moving object NHM other than the human HM is reflected in the video VD_OR, the description of the interaction between the human HM and the moving object NHM reflected in the video VD_OR or the summary of the description is given. The caption information CAP constitutes the video VD_VR together with the virtual space VS. The caption information CAP is displayed near the display area of the virtual space VS when the video VD_VR is output from the display device 30.

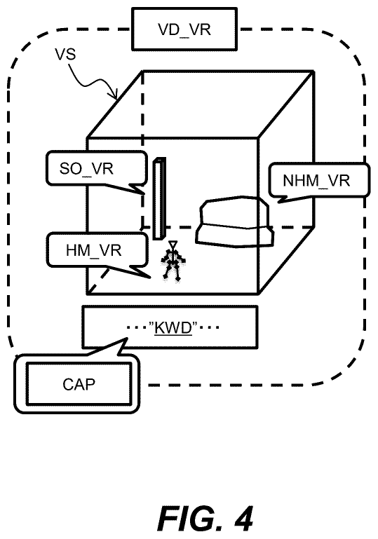

Returning to FIG. 2, the reproduction processing can be performed based on the search information SAR input from the input device 40. For example, when the search information SAR includes the position and time information, the reproduction unit 28 specifies the scene information SCN having the position and time information matching the search information SAR in cooperation with the scene information recording unit 27. The reproduction unit 28 performs reproduction processing to generate the video VD_VR from the specified scene information SCN and outputs the video VD_VR to the display device 30. When the keyword information KWD is further included in the search information SAR, in the reproduction processing, the explanation corresponding to the keyword information KWD in the caption information CAP may be highlighted (see FIG. 4).

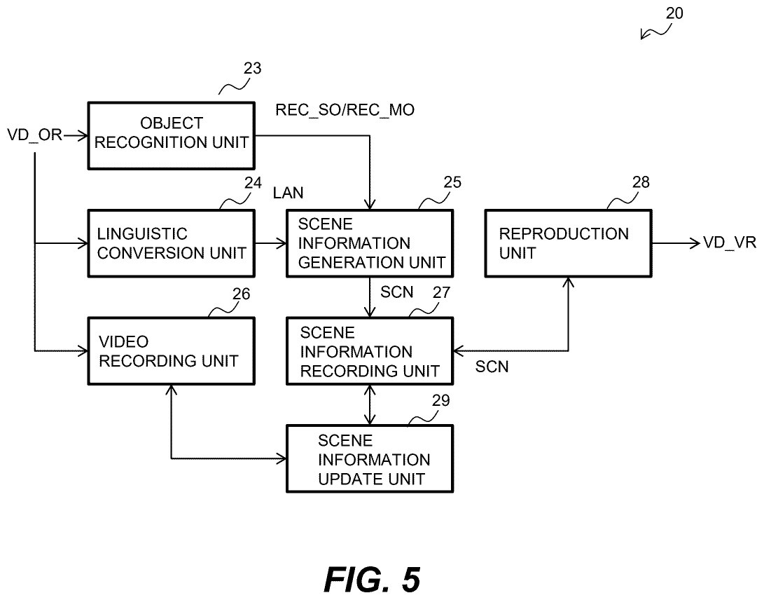

FIG. 5 is a block diagram showing another example of the functional configuration of the data processing device 20 shown in FIG. 1. In FIG. 5, a scene information update unit 29 is depicted in addition to the function blocks (object recognition unit 23 and the like) shown in FIG. 2. These function blocks are realized by cooperation of the processing circuitry 21 and the memory device 22 shown in FIG. 1, for example.

The scene information update unit 29 performs an “update process” for updating the scene information SCN. In the update processing, first, in cooperation with the scene information recording unit 27, a specific language is detected from the linguistic information LAN included in the scene information SCN. The specific language is set in advance by, for example, a user of the management system. The specific language is exemplified by a language representing a state recognized as an abnormality from the aspect of health maintenance or traffic safety of human HM. Examples of the state recognized as abnormal from the aspect of health maintenance or traffic safety include falling, crouching, bleeding, and abnormal posture of human HM.

When the specific language is detected, in the update processing, the video VD_OR of the generation source of the linguistic information LAN is specified in cooperation with the video recording unit 26. Then, the linguistic processing is performed to re-assign the linguistic information LAN to the scene shown in the specified video VD_OR. In the linguistic processing, for example, text describing a detailed situation corresponding to a specific language is generated using vision language models (VLM models). Thus, the detailed linguistic information LAN about the situation related to the specific language included in the scene shown in the specified video VD_OR is generated. When the detailed linguistic information LAN is generated, the scene information SCN is updated in cooperation with the scene information recording unit 27 in the update processing.

### 3. EFFECT

According to the embodiment described above, reproduction processing of a scene shown in video VD_OR is performed. In the reproduction processing, the virtual space VS abstractly representing the real space RS shown in the video VD_OR is rendered, and the virtual human HM_VR abstracting the human HM shown in the video VD_OR is further rendered in the virtual space VS. Therefore, the data size required for reproducing the scene of the video VD_OR can be reduced as compared with the case where the video VD_OR is used as it is. In addition, since the virtual human HM_VR is used, the privacy of the human HM can be protected.

What is claimed is:

1. A management system for camera footage, comprising:
a memory device configured to store the camera footage;
processing circuitry configured to perform various processing; and
a display configured to output an image,
wherein the processing circuitry is configured to:
generate recognition information on an object shown in the camera footage by object recognition processing on the camera footage stored in the memory device;
generate linguistic information on a scene shown in the camera footage by linguistic processing on the camera footage stored in the memory device;
when the recognition information on the object include recognition information on a human, generate scene information in which the recognition information on the human is associated with the linguistic information on the scene generated by the linguistic processing on the camera footage in which the human is recognized and store the scene information in the memory device; and
perform reproduction processing on a scene shown in the camera footage based on the scene information stored in the memory device,
wherein the reproduction processing comprises;
rendering an abstracted image of a space included in the camera footage based on the recognition information on a static object included in the scene information;
rendering an abstracted image of the human included in the camera footage on the abstracted image of the space based on the recognition information on the human included in the scene information;
generating caption information on the scene based on the linguistic information on the scene included in the scene information; and
generating a reproduced image to be output from the display device by adding the caption information to the abstracted image of the space in which the abstracted image of the human is rendered.

2. The system according to claim 1,
wherein the processing circuitry is configured to:
when the recognition information on the object includes recognition information on a moving object other than a human, add recognition information on the moving object to the scene information,
wherein the reproduction processing further comprises:
rendering an abstracted image of the moving object on the abstracted image of the space based on the recognition information on the moving object included in the scene information.

3. The system according to claim 1,
wherein the processing circuitry is further configured to:
detect a specific language set in advance by referring to the linguistic information on the scene included in the scene information;
when the linguistic information on the scene including the information on the specific language is detected, regenerates detailed linguistic information on the scene shown in the camera footage by performing the linguistic processing again on the camera footage that is a generation source of the detected linguistic information on the scene; and
update the scene information including the information on the specific language based on the detailed linguistic information on the scene.

4. The system according to claim 1, further comprising:
an input device to which information is input,
wherein the processing circuitry is further configured to:
when search information on a scene shown in the camera footage is input from the input device, identify the scene information matching the search information based on the search information and the linguistic information on the scene included in the scene information stored in the memory device,
wherein the reproduction processing is performed based on the scene information matching the search information.

5. The system according to claim 1, wherein:
the abstracted image of the space includes a three-dimensional image obtained by abstracting the space shown in the camera footage; and
the abstracted image of the human includes a three-dimensional image obtained by abstracting the human shown in the camera footage.
